(19) United States
(12) Patent Application Publication
(10) Pub. No.: US 2006/0070252 A1
(43) Pub. Date: Apr. 6, 2006

(54) Ruler with rubber/plastic composition

(76) Inventors: Javier Verdura, Milford, CT (US); Wayne S. Marcus, Fairfield, CT (US); Peter Michaelian, Tappan, NY (US); Stuart David Farnworth, Westport, CT (US)

Correspondence Address: ALIX YALE & RISTAS LLP, 750 MAIN STREET, SUITE 1400, HARTFORD, CT, 06103, US

(21) Appl. No.: 11/230,270

(22) Filed: Sep. 19, 2005

Related U.S. Application Data
(60) Provisional application No. 60/611,358, filed on Sep. 20, 2004.

(51) Int. Cl. B43L 7/00

(52) U.S. Cl. 33/494; 33/493

(57) ABSTRACT

A ruler for school children comprises a plastic molded frame and an insert affixed to the frame. The insert preferably has a resilient rubber composition which extends through openings in the frame and projects above the viewing surface to provide a measuring scale and tactile gripping elements.

### CROSS-REFERENCE TO RELATED APPLICATION

This application claims the priority of U.S. Provisional Application No. 60/611,358 filed on Sep. 20, 2004.

### FIELD OF THE INVENTION

This invention relates generally to rulers. More specifically, this invention relates to rulers which are adapted for use by children.

### BACKGROUND OF THE INVENTION

Measuring devices such as rulers are a well-known and commonly used commodity. While rulers may be used in a variety of professional or educational settings, elementary school children very commonly use them. Rulers used by elementary school children conventionally provide measuring and straight edge functionality. It would also be preferable to provide a non-skid surface during use as well as a desirable aesthetic look and tactile feel. The traditional wood, metal or all plastic rulers fail to provide one or more of these desirable attributes.

### SUMMARY OF THE INVENTION

Briefly stated, the invention in a preferred form is a composite ruler having a longitudinally extending frame. The frame comprises a viewing surface, a support surface and opposing edges longitudinally extending between opposing ends. In an advantageous embodiment, the edges are inclined below the support surface so that the support surface defines a cavity.

An insert is disposed adjacent the support surface. The insert partially fills the frame cavity and extends longitudinally from one end to the opposing end. In embodiments wherein the frame defines apertures between the viewing surface and the support surface, it is advantageous for the insert to extend from the cavity, through the aperture and project above the viewing surface.

The insert is preferably prepared from a resilient material such as a resilient polymer. Elastomers, synthetic rubbers and natural rubbers are suitable. The resilient polymer may also include other additives such as coloring agents, inhibitors, plasticizers, lubricating agents, fillers, curing agents, reinforcing agents and other materials which provide visually striking and tactile qualities.

The frame is preferably made from polymeric material that can be molded and is a harder non-resilient polymer in contrast to that of the insert. The frame has a series of apertures in the shape of numerals which define a linear measurement scale. The apertures extend from the support surface to the viewing surface so that portions of the insert extend through the apertures and protrude above the viewing surface. In addition, the frame preferably has another array of apertures which provide communication between the support surface and the viewing surface. The insert extends through the array of apertures to form a central array of longitudinally spaced, parallel vertical gripping ribs. The gripping ribs are preferably configured so that the vertical height above the viewing surface decreases as the distance of the rib from the center of the array increases. In addition, the transverse width of the ribs also decreases as the longitudinal distance from the center of the array increases.

An object of the invention is to provide a new and improved ruler adapted for use by children.

Another object of the invention is to provide a ruler having a composite construction with desirable aesthetic and tactile elements.

### BRIEF DESCRIPTION OF THE DRAWINGS

Other objects and advantages of the invention will be evident to one of ordinary skill in the art from the following detailed description made with reference to the accompanying drawings, in which:

FIG. 1 is a top plan view of one embodiment of the inventive composite ruler.

FIG. 2 is an edge elevational view of the composite ruler of FIG. 1.

FIG. 3 is a bottom plan view of the composite ruler of FIG. 1.

FIG. 4 is an enlarged right end elevational view of the composite ruler of FIG. 1.

FIG. 5 is a top plan view, partly in phantom, of another embodiment of the inventive composite ruler of FIG. 1.

FIG. 6 is a bottom plan view of the composite ruler of FIG. 5.

FIG. 7 is a bottom plan view, partly in phantom, of a frame component for the inventive composite ruler of FIG. 5.

FIG. 8 is an enlarged sectional view of the composite ruler of FIG. 5 taken along the line 8-8 thereof.

FIG. 9 is an enlarged end elevational view of the composite ruler of FIG. 5.

### DETAILED DESCRIPTION OF THE PREFERRED EMBODIMENTS

With reference to the drawings wherein like numerals designate like components throughout the Figures, rulers having a composite construction which are especially adapted for children are generally designated by the numerals 10 (FIGS. 14) and 100 (FIGS. 5-9).

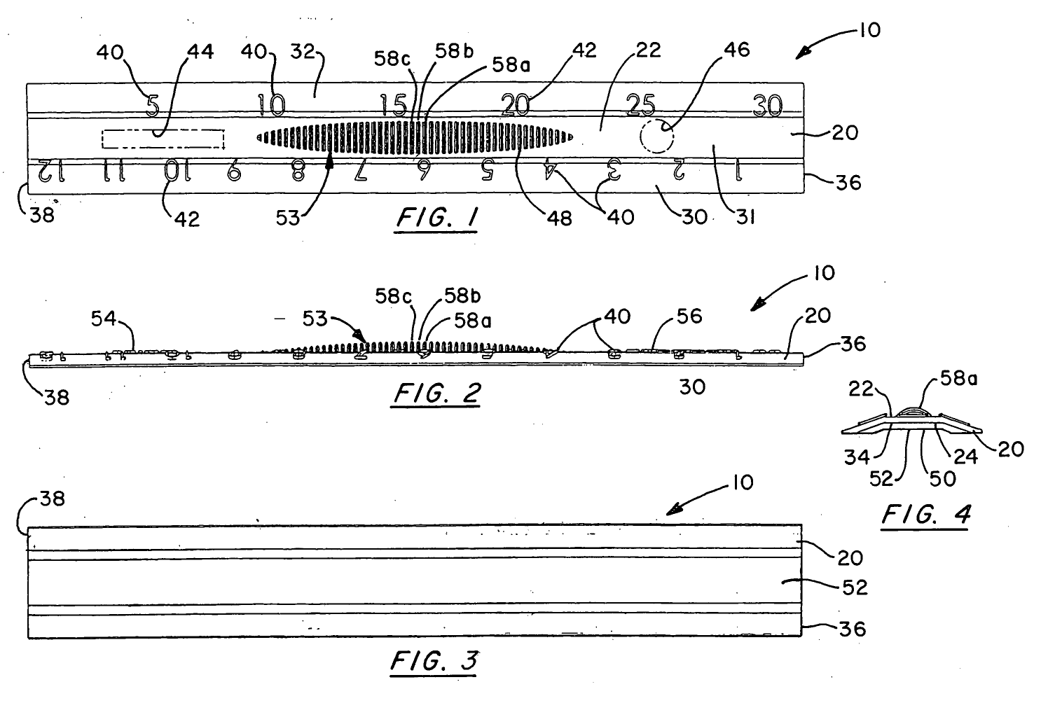

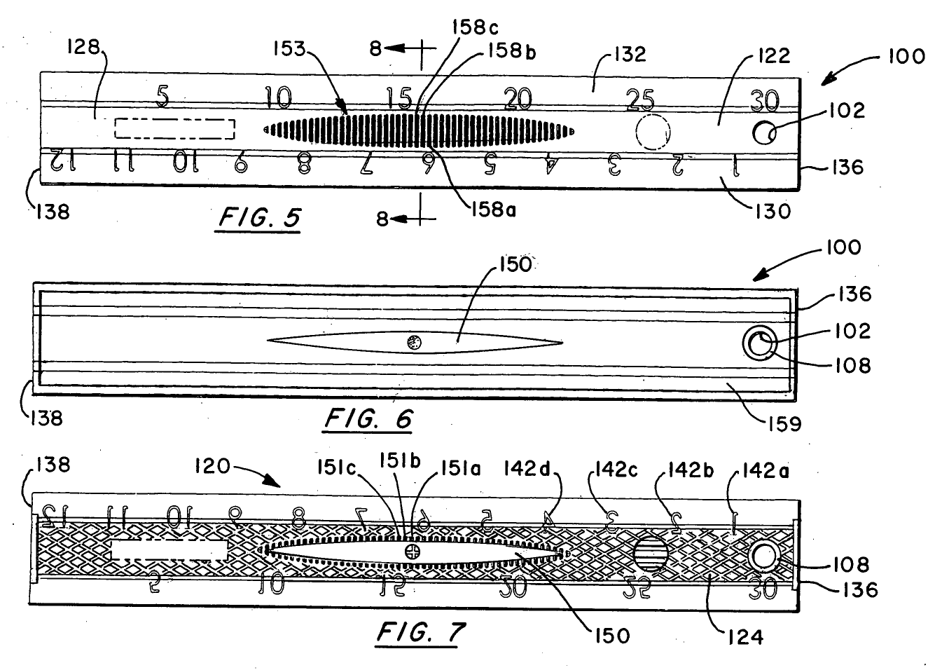

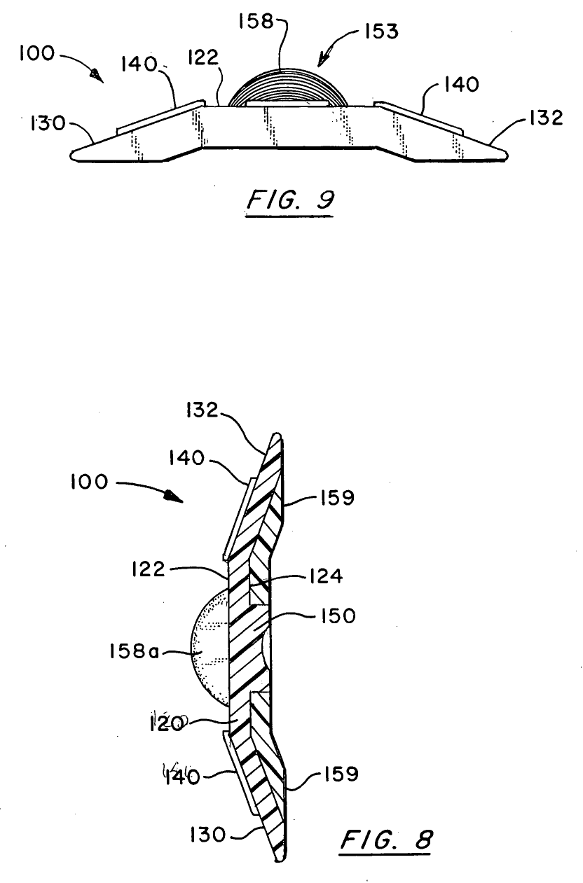

As shown in FIGS. 1-4, the composite ruler 10 comprises a frame 20 preferably having a semi-rigid plastic composition. The frame includes an upper viewing surface 22, an underside support surface 24 and opposing strip-like inclined edges 30, 32 and a medial strip 31 longitudinally extending in linear fashion between opposing ends 36, 38. The edges 30, 32 at their peripheral underside define a support plane (FIG. 4). One or both edges at their upper surface (which is a portion of viewing surface 22) may include indicia 40 such as numerals or graduated lines (not shown), if desired. The indicia preferably define at the opposed edges an English and a metric measuring scale as shown in FIG. 1. In an advantageous embodiment shown best in FIG. 4, the edges 30, 32 are inclined transversely to the longitudinal direction to define a cavity 34.

It is possible to make the frame 20 from a variety of materials such as metal, wood or polymer. Preferably, the frame is made from a polymeric material that can be molded. For example, the frame could be made from a harder, non-resilient polymer such as, for example, acetal, acrylic, cellulosic, fluoroplastic, ketone based polymers such as poly(aryl)ether ether ketone, nylon, polyamide-imide, polyarylate, polycarbonate, polyolefin and polyester. The polymeric material may include other additives such as coloring agents, inhibitors, plasticizers, lubricating agents, fillers, curing agents, reinforcing agents and/or other materials to achieve desirable chemical and physical properties for the frame.

The frame 20 advantageously defines a plurality of apertures communicating between the underside support surface 24 and the viewing surface 22. The apertures may take a number of forms, for example, numerals 42 for a measurement scale, openings 46 for indicia such as names or lines, decorative elements, gripping elements and/or tactile elements. The apertures preferably define measurement numbers for the linear measuring scales. In one preferred embodiment there are also a plurality of parallel, transversely oriented apertures 48 longitudinally arranged along the centerline of the frame.

A multi-faceted insert 50 is disposed adjacent the support surface 24. Advantageously the insert at least partially fills the frame cavity 34. The insert 50 may fill the cavity completely; however, the additional material used will add to the weight and cost of the composite ruler. The ends of the insert 50 may be aligned with the ends 36, 38 of the frame. However, such alignment is not necessary for function of the composite ruler and the ends of the insert may be disposed inwardly or outwardly of the respective ends of the frame to provide a desired aesthetic appearance. The insert will typically extend substantially continuously along the longitudinal length of the frame support surface and have smooth planar underside surface or surfaces 52 parallel to support surface 24. In less preferred variations of the invention, the insert may not extend completely or continuously from end to end. In embodiments of the invention comprising frame apertures 42, 44, 46, 48, the insert extends continuously from the cavity, through the apertures and projects above the viewing surface 22 to, among other features, highlight and make tactile the measuring scales. A central array 53 of ribs also provides a child friendly tactile feel of the ruler.

The insert 50 is preferably prepared from a resilient polymer. As used herein the term “resilient” means the ability of the material to be deformed by a user's hands, for example, a fingernail, and to recover its size and form following this deformation. Some resilient polymers include, for example, elastomers, synthetic rubbers and natural rubbers. The resilient polymer may include other additives such as coloring agents, inhibitors, plasticizers, lubricating agents, fillers, curing agents, reinforcing agents and/or other materials to achieve desirable chemical and physical properties for the insert.

The use of a resilient polymer for the insert 50 provides a slip resistant surface for the composite ruler. In embodiments of the invention comprising frame apertures, the use of a resilient polymer for the insert provides a desirable user-friendly tactile feel for the numerals 40, longitudinally spaced vertical parallel ribs 58a, 58b, 58c . . . , indicia 54 and decorative elements 56, all of which provide gripping elements and/or tactile elements projecting above the viewing surface.

In advantageous embodiments, additives are used in the frame 20 and/or insert 50 to provide different and contrasting colors for these elements. Thus, for example, the frame may be colored blue and the insert may be colored green. Any numerals, indicia, decorative elements, gripping elements or tactile elements projecting above the viewing surface would also be green against the blue background of the viewing surface. A composite ruler with this multiple colored appearance is expected to have great appeal with school children. The use of contrasting colors would also facilitate use of the composite ruler by allowing the contrasting markings to stand out from the frame.

The composite ruler 10 can be made by molding. For example, the frame 20 could be molded from a pre-selected polymer. The molded frame would include any desired indicia openings or apertures as previously described. The molded frame would be removed from the mold and any necessary secondary operations could be performed, for example, to remove mold flashing. The frame could next be positioned in a second mold. A resilient polymer is disposed within the mold, either prior to or during the molding process. Application of heat and pressure to the mold will cause the resilient polymer to flow into the frame cavity. In embodiments of the frame comprising frame apertures, the resilient polymer would flow through any apertures and over adjacent portion of the viewing surface. The composite ruler would be removed from the mold and readied for sale or use. Molding of the insert 50 through the frame apertures is especially advantageous as the insert material extending through the aperture and over the viewing surface will help secure the insert to the frame.

With reference to FIGS. 5-9, a second embodiment of a ruler in accordance with the present invention is generally designated by the numeral 100. Ruler 100 includes a hang hole 102 and principally differs from ruler 10 in terms of the configuration of the frame 120. Frame 120 includes an upper viewing surface 122 having a planar medial strip 128 and inclined edges 130, 132 which are substantially identical to edges 30, 32. Apertures 142a, 142b, 142c . . . (FIG. 7) in the shape of numbers for the measuring scales are longitudinally spaced at opposite inclined edges and extend between the viewing surface 122 and underside support surface 124. As best illustrated in FIGS. 6 and 7, the underside of the frame includes end walls 136, 138 which provide additional reinforcement for the frame. An annular wall 108 defines the hang hole opening 102.

The central portion of the frame includes a tapered edge-shaped platform 150 which partially defines a series of openings 151a, 151b, 151c . . . , to provide for pre-form communication of the insert to form the central array 153 of upwardly projecting ribs 158a, 158b, 158c . . . during the insert molding process.

As illustrated in FIG. 7, the underside of the frame 120 also includes a checked or corrugated pattern at the underside of the support surface 124 to facilitate the retention and adhesion of the insert to the molded frame. It will be appreciated, as best illustrated in FIG. 7, that apertures 142 in the shape of the numerals for the measurement scales are formed in the frame. When the insert is molded into the cavity 134 of the frame, the insert material extends through the apertures to project upwardly above the viewing surface to form the raised numerals 140 as well as the raised indicia and decorative elements, and in particular, the tactile gripping ribs 158.

In one preferred embodiment of the central rib array 153, the vertical protrusion or height of the gripping ribs 158 slightly decreases from the center rib or ribs as the longitudinal distance from the center rib or ribs increases. In addition, the transverse width of the ribs also slightly decreases as the distance of the rib from the center of the ruler increases. These relationships provide an aesthetically pleasing appearance as illustrated in the drawings. The array 153 comprises ribs which are preferably substantially equally spaced and parallel in their appearance. Though it should be appreciated that other tactile rib-like configurations are also certainly possible. The bottom surfaces 159 of the insert 150 may be planar and function as a non-skid interface.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and scope of the present invention.

What is claimed:

1. A ruler comprising:
a longitudinally extending frame having opposing ends and opposing, downwardly angled edges longitudinally extending from one end to the opposing end and an upper viewing surface and a lower support surface defining a cavity and a plurality of apertures extending between the viewing and support surfaces; and
an insert attached to the frame and at least partially filling the cavity and extending through the apertures to protrude above the viewing surface.

2. The ruler of claim 1 wherein the frame comprises a non-resilient polymer material and the insert comprises a resilient polymer material.

3. The ruler of claim 1 wherein the frame has a plastic composition and the insert is composed of a material selected from at least one of an elastomer or a rubber.

4. The ruler of claim 1 wherein the insert extends longitudinally from one end to the opposing end.

5. The ruler of claim 1 wherein the insert comprises coplanar transversely spaced longitudinally extending strips.

6. The ruler of claim 1 wherein the insert comprises downwardly angled strips longitudinally extending from one end to the opposing end.

7. The ruler of claim 1 wherein the frame defines a linear series of apertures having the shape of numerals and the insert extends from the cavity, through the linear series of apertures and projects above the viewing surface to form a raised measurement scale.

8. The ruler of claim 1 wherein the frame defines a center axis and a plurality of spaced apertures disposed along the center axis, at least some of the apertures being elongated in a direction orthogonal to the center axis, each aperture connects the viewing surface to the support surface, and the insert extends from the cavity, through the apertures and projects above the viewing surface.

9. The ruler of claim 8 wherein a portion of the insert that projects above the viewing surface forms an array of vertical ribs defining a longitudinal center

10. The ruler of claim 9 wherein said ribs are longitudinally spaced and have a transverse width that decreases as the distance of the rib increases from the center of the array.

11. The ruler of claim 10 wherein the vertical height of the ribs decreases as the longitudinal distance from the center of the array increases.

12. The ruler of claim 1 wherein the frame defines a plurality of spaced apertures disposed along the downwardly angled edge, at least some of the apertures being in the form of indicia, each aperture connects the viewing surface to the support surface and the insert extends from the cavity, through the apertures, and projects above the viewing surface.

13. A method of making a ruler comprising:
molding a longitudinally extending frame having opposing ends and opposing, downwardly angled edges longitudinally extending from one end to the opposing end and a viewing surface and a support surface defining a cavity wherein the frame defines an aperture therein connecting the viewing surface to the support surface; and
molding a polymeric material onto the frame so that the polymeric material partially fills the cavity and extends through the aperture and projects above the viewing surface.

14. A ruler comprising:
a longitudinally extending frame having opposing ends and opposing downwardly angled edges longitudinally extending from one end to an opposing end and an upper viewing surface and an underside support surface, the frame defining a center axis and a plurality of longitudinally spaced apertures, each aperture connecting the viewing surface to the support surface; and
an insert formed of resilient material attached to the frame and at least partially engaging said support surface, a portion of the insert extending through the apertures and projecting above the viewing surface to form a plurality of longitudinally spaced ribs.

15. The ruler of claim 14 wherein the ribs are parallel.

16. The ruler of claim 15 wherein the ribs each extend substantially orthogonally to the center axis.

17. The ruler of claim 14 wherein the ribs form a generally symmetric array having a longitudinal center.

18. The ruler of claim 17 wherein the height of each rib above the viewing surface decreases as the longitudinal distance from the center increases.

19. The ruler of claim 17 wherein the transverse width of each rib decreases as the longitudinal distance from the center increases.

20. The ruler of claim 14 wherein the frame has a pair of longitudinally spaced apertures in the shape of numerals forming a pair of transversely opposite measuring scales.
